(19) United States
(12) Patent Application Publication
(10) Pub. No.: US 2023/0217967 A1
(43) Pub. Date: Jul. 13, 2023

(54) OXYGEN REMOVAL TECHNIQUE FOR A FLEXIBLE BAG IN A FOOD PRESERVATION SYSTEM

(71) Applicant: GREENLIFETECH CORPORATION, Banner Elk, NC (US)

(72) Inventors: Bruce B. Roesner, Banner Elk, NC (US); Michael A. Rall, Boone, NC (US); Sebastian Bendik Bartlett, Sandy Springs, GA (US); Samantha Rettig, Asheville, NC (US); Pedro A. Murcia, Boone, NC (US); Victoria Jeanne Clare, Mint Hill, NC (US); Matthew Michael, Newland, NC (US)

(21) Appl. No.: 18/095,961

(22) Filed: Jan. 11, 2023

Related U.S. Application Data
(60) Provisional application No. 63/298,540, filed on Jan. 11, 2022.

(51) Int. Cl. A23L 3/3418; B65D 81/20; G01G 19/414

(52) U.S. Cl. CPC A23L 3/3418; B65D 81/2084; G01G 19/4144

(57) ABSTRACT

A food preservation system includes a stand with a base and an arm extending perpendicular to a top surface of the base. A lid is connect to the art, and a rigid element is connect to the arm and defines an opening. The rigid element is closer to the top surface of the base than the lid. A first conduit fluidically connects the lid and the arm. A second conduit fluidically connects the lid and the arm.

### CLAIM OF PRIORITY

This application claims priority under 35 U.S.C. ¶ 119(e) to U.S. patent application Ser. No. 63/298,540, filed on Jan. 11, 2022, the entire contents of which are hereby incorporated by reference.

### TECHNICAL FIELD

This invention relates to food preservation.

### BACKGROUND

Today there are literally hundreds of patents describing various method or techniques for extending the life of foods and drinks. These patents typically describe three basis techniques or combinations thereof. The intent of just about all of these devices is to reduce the amount of oxygen which makes up 21% of air to which the consumable is exposed. Of course, reducing the temperature, as in refrigeration, slows down the process of bacteria growth and extends the life span of food and drinks, but is not considered is this analysis.

The first technique involves creating a vacuum. In reality, only various degrees of a partial vacuum are created. As the vacuum level is increased (lower pressure), the amount of oxygen available to react with the food or wine is decreased and the life of the material is increased. The challenges associated with this approach are that vacuum systems are expensive, containers to sustain low pressures are expensive, and only a portion of the oxygen is removed providing limited benefits. Even with a high-level vacuum capable of reducing the pressure to 5 psi absolute (approximately one-third of atmospheric pressure), only two-thirds of the oxygen has been removed. In other words, one-third of the oxygen remains.

The second technique, and by far the most popular, is to replace air (21% oxygen) with an inert gas such as nitrogen or argon. The concept around this approach is quite simple. By replacing the air (oxygen) with these inert gases, the amount of oxidation and deterioration of the consumable, is reduced. This technique is used worldwide and does indeed result in the enhanced shelf life of food and wine. Systems that significantly reduce the level of oxygen (0.1 to 1%) have extended the shelf life of wines indefinitely while food has been extended by months. However, there are many issues associated with the technique. The use of inert gas has been found to be a cost-effective means of preserving consumables on a large-scale basis, but most homes and facilities do not have easy access to these types of gases. While there are dedicated businesses already established that bottle and distribute these gases to major consumers of the gases, this method does not lend itself to the typical user because of gas delivery issues as well as the handling of the heavy high-pressure tanks in which the gases are maintained.

Finally the third approach uses chemicals to slow the deterioration of consumables. Needless to say, this is rather risky (possibility of chemicals entering the food chain) and quite costly. Consequently, the method is rarely used beyond well controlled preservatives in food and cosmetics.

### SUMMARY

The technique of removing oxygen from a flexible container described offers a significant advantage over the previous described method of removing oxygen from a rigid sealed container for certain segments of the food chain. As described, it has the distinct advantage in such areas as the purchase of fresh produce in grocery stores in that such flexible bags are already being used in the purchase of fresh fruits and vegetables. The technique described offers the least amount of disruption to a process already in place in frequently used.

We anticipate that this technique could be delivered throughout the food chain from the farm, through distribution, retail and ultimately home or retail use, as well as other areas outside of the food chain such as flowers and pharmaceuticals. This capability will be highly valued in both established as well as emerging markets. Also, the cost of implementation and usage is quite reasonable.

While generally described as computer implemented software embodied on tangible media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is an example food presentation system.

FIG. 2 is another example food preservation system.

FIG. 3 is again another example food preservation system.

FIG. 4 is yet another example food preservation system.

### DETAILED DESCRIPTION

In general, flexible bags are commonly used to transport produce in many segments of the food chain. For example, grocery stores use flexible bags to transport produce from the grocery store to the households. The described implementations are cost-effective techniques for connecting inlets or tubes to a flexible plastic bag to eliminate, minimize or otherwise reduce oxygen in the bag containing produce. Once the oxygen is reduced, a seal is formed to prevent or other reduce oxygen seeping back into the bag. Rather than try to form a seal directly between a flexible bag and inlets or hoses, the describe implementations described places the flexible bag between two temporary rigid surfaces, one of which has the associated inlets connected. The described food preservation system can be used with one or elements described in PCT/US2020/053592 entitled “Food Preservation Method”, which is incorporated by reference.

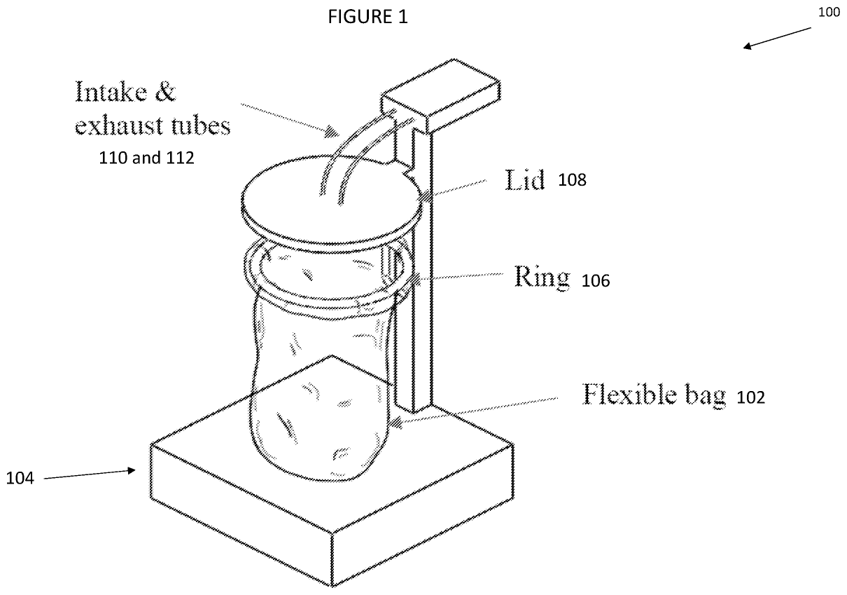

FIG. 1 is a food preservation system 100 in accordance with some implementations of the present disclosure. As illustrated, food preservation system 100 includes flexible bag 102 for storing produce. For example, the flexible bag 102 along with its contents is placed on a stand 104 and the open portion of the bag is rolled over a ring 106 (e.g., rigid ring). A lid 108 is then placed on top of the ring 106 with a portion of the bag 102 between a bottom portion of the lid 108 and the top portion of the ring 106, which forms a seal.

In some implementations, the lid 108 can be hinged to rotate down or raised. Alternatively or in combination, the lid 108 can also be raised or lowered vertically to form the seal. Once a seal is formed, the two tubes 110 and 112 can be used to cycle gas in the container and remove the oxygen. In some instances, the lube 110 comprises an inlet for pumping or otherwise introducing inert gas (e.g., nitrogen) onto the flexible bag 102. The tube 112 can be an outlet that removes gas containing oxygen and pass the oxygen-rich gas to an oxygen removal system (not illustrated). For example, the inlet tube 110 may pump nitrogen into the bag 102 and the exhaust tube 112 can remove gases including displace oxygen. In some implementations, the ring 106 can include holes on the perimeter that provides a slight vacuum to hold the portion of the flexible bag 102 rolled over the ring 106 in place. That portion of the flexible bag 102 can be held in place, in combination or alternatively, using a tacky surface, an adhesive, a barbed surface, and/or other elements without departing from the scope of the disclosure.

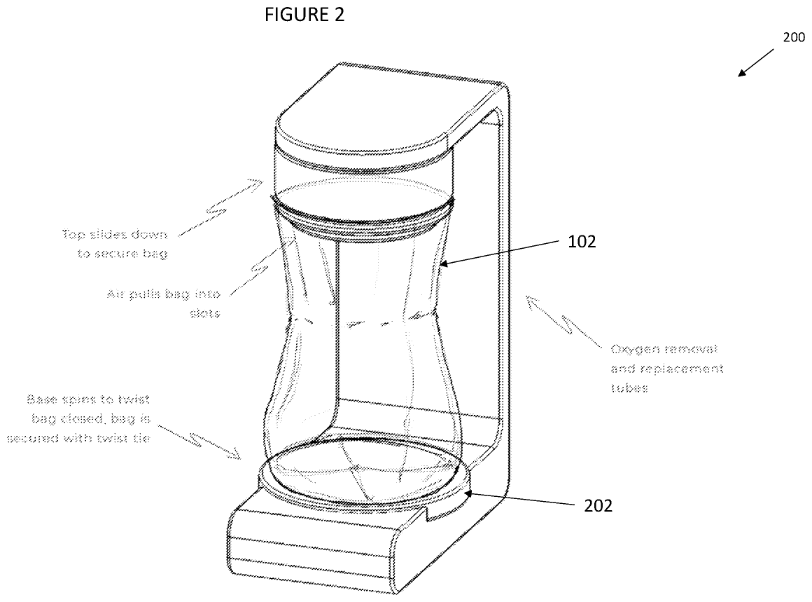

FIG. 2 illustrates an example of a food preservation system 200 in accordance with some implementations of the present disclosure. As illustrated, the food preservation system 200 includes a rotating stand 202 on which the bag 102 with its produce is positioned. Once the process of removing the oxygen is complete, the bag 102 and its contents would be rotated which would cause the bag to become sealed. For example, an upper portion of the bag 102 is twisted to form a seal in that portion of the bag 102. A clamping device, a twister tie, or other fastener can be used to hold the seal in place.

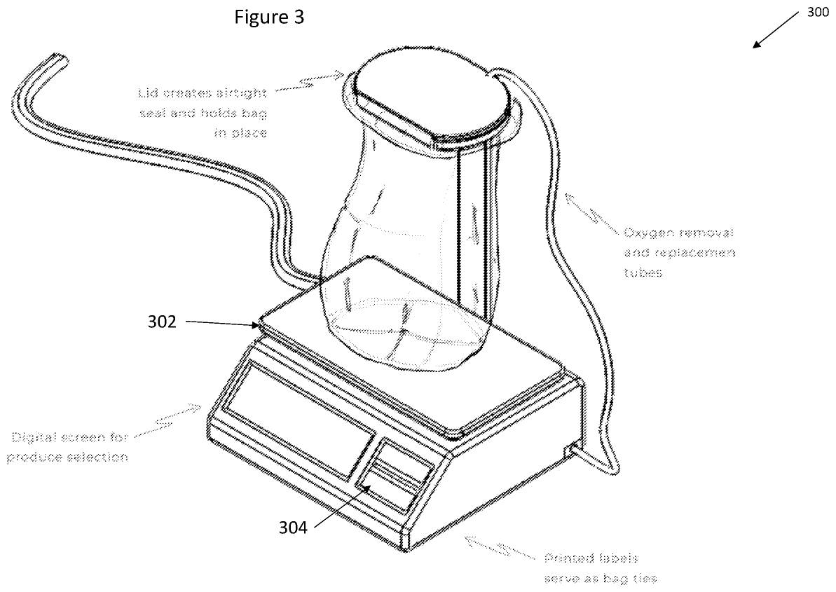

FIG. 3 illustrates another example of a food preservation system 300 in accordance with some implementations of the present disclosure. As illustrated, the system 300 includes a weight scale 302 and a label dispenser 304 (e.g., bar code dispenser). Once the bagged produce is placed on the scale and while the oxygen is being removed, the produce type can be entered into the system 300. In these instances, the total price can be automatically calculated and a label with a bar code and/or other information can be printed and applied to the bag to identify the produce and the price. In doing so, the transaction time at checkout can be reduced by scanning the label. As previously mentioned, the example label can include other information without departing from the scope of the disclosure such as a unique identifier, a packaged date, a sell-by date, and/or other information.

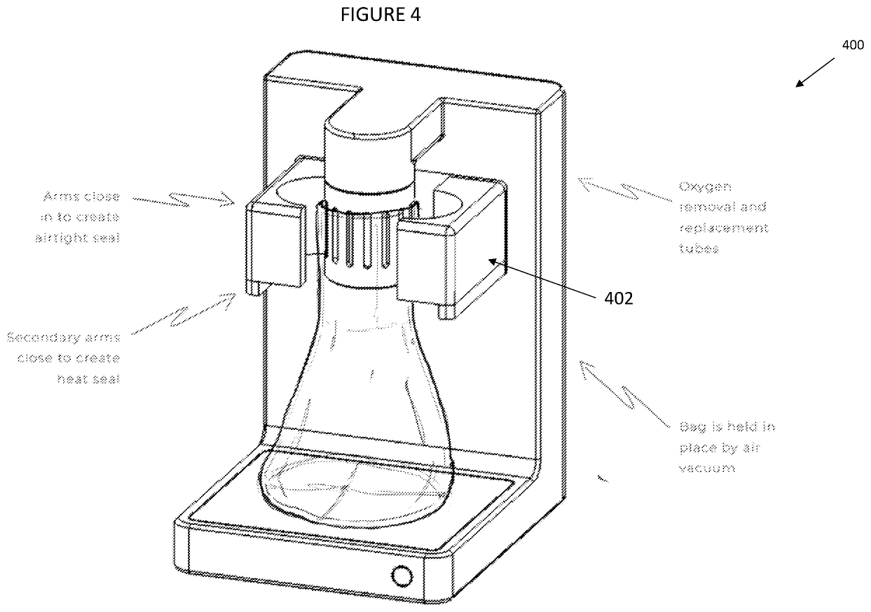

FIG. 4 illustrates yet another example of a food preservation system 400 in accordance with some implementations of the present disclosure. In this example, the food preservation system 400 includes a clamp 402 to form a seal. The food preservation system 400 can include a cylinder 404 such that the claim 402 and the cylinder 404 form the seal. The food preservation system 400 can use other shapes without departing from the scope of the disclosure. During the oxygen removal process, the open end of the bag around a cylinder 404 and the bag can be sealed between the outer clamp 402 and the inner cylinder 404 using a clamping action.

Subsequent to the oxygen removal, the bag can be sealed so that when removing the bag with its produce from the stand, the oxygen deprived gas inside the bag is not again replaced with air. In some implementations, a mechanical clamping mechanism such as a twist tie can be used. As already shown in FIG. 2, the bag can be be rotated to close off the bag prior to using the mechanical clamp.

Alternatively or in combination, the bag can be seal using a heat weld or other process for adhering a portion of the bag material to another portion of the bag. Before removing the bag from the stand, a clamping structure with an embedded heat source would be used to heat seal the bag to trap the oxygen deprived gas inside. Other processes may be used without departing from the scope of the disclosure. Oxygen may be removed from a flexible bag using other schemes different from the described schemes and can be used in alternatively or in conjunction with a previously described technique of removing oxygen from air.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system for removing oxygen from a flexible container the system comprising:
a recirculation pump comprising an intake and an exhaust, wherein the intake comprises a first connector fluidically couple to a flexible container, and the exhaust is fluidically connected to an oxygen removal device;
the oxygen removal device comprising:
an inlet fluidically connected to the exhaust of the recirculation pump;
an outlet including a second connector fluidically connected to the intake; and
a flexible container coupled to the oxygen removal device.

2. The system of claim 1, wherein the flexible container is temporarily sealed between two rigid surfaces.

3. The system of claim 2, wherein at least one of the two rigid surfaces rotate into position or positioned along an axis.

4. The system of claim 1, further comprising a rotating disk positioned to contact a bottom of the flexible bag, wherein the rotating disk rotates the bottom of the bag to form a seal.

5. The system of claim 1, wherein at least one of the two rigid surface includes on a perimeter an adhesive, hooks, clamps, or vacuum to position an upper portion of the flexible container.

6. The system of claim 1, further comprising a mechanical tie or a heating element for sealing the flexible container.

7. The system of claim 1, further comprising a scale positioned under the flexible container to measure a weight.

8. The system of claim 7, further comprising a printer for labels identifying at least one of a material, a weight, or price of the contents.

9. A food preservation system, comprising:
a stand including a base and an arm extending perpendicular to a top surface of the base;
a lid connected to the arm;
a rigid element defining an opening and connected to the arm, wherein the rigid element is closer to the top surface of the base than the lid;
a first conduit fluidically connecting to the lid and the arm; and
a second conduit fluidically connecting the lid and the arm.

10. The food preservation system of claim 9, wherein the lid is rotatably connected to the arm.

11. The food preservation system of claim 9, wherein the rigid element comprise a ring.

12. The food preservation system of claim 11, wherein a central axis of the lid is parallel to a central axis of the ring.

13. The food preservation system of claim 9, wherein the rigid element includes on a perimeter at least one of an adhesive or one or more hooks.

14. The food preservation system of claim 9, wherein the base includes at least one of a scale or label printer.

15. The food preservation system of claim 9, wherein the base includes a rotatable element positioned below the rigid element.

16. The food preservation system of claim 9, wherein the rigid element comprises a clamp.
